(19) United States
(12) Patent Application Publication
(10) Pub. No.: US 2011/0265815 A1
(43) Pub. Date: Nov. 3, 2011

(54) METHOD OF CLEANING SUPPORT PLATE

(75) Inventors: Tatsuhiro MITAKE, Kawasaki-shi (JP); Atsushi MATSUSHITA, Kawasaki-shi (JP)

(73) Assignee: TOKYO OHKA KOGYO CO., LTD., Kawasaki-shi (JP)

(21) Appl. No.: 13/086,145

(22) Filed: Apr. 13, 2011

(30) Foreign Application Priority Data
Apr. 28, 2010 (JP) 2010-104522

(51) Int. Cl. B08B 7/00

(52) U.S. Cl. 134/1.1; 134/7; 134/1

(57) ABSTRACT

The present invention achieves a method of cleaning a support plate according to which, while no waste solution is produced after cleaning the support plate, the support plate can be treated at low cost. The method of cleaning the support plate includes the step of performing an organic substance and metal each adhered to the support plate by causing dry ice particle to hit the support plate, the support plate being a support plate from which a substrate has been stripped.

### RELATED APPLICATIONS

This application claims priority under 35 U.S.C. §119(a)-(d) to Japanese Patent Application No. 2010-104522 filed Apr. 28, 2010, the entire contents of which are hereby incorporated by reference.

### FIELD OF THE INVENTION

The present invention relates to a method of cleaning a support plate that is attached to and supports a substrate to thin the substrate.

### BACKGROUND

In recent years, there has been an increasing demand for higher integration and reduction in size and thickness of semiconductor chips to be mounted on electronic devices. Accordingly, the substrate that is a base of such semiconductor chips must be thinned, by grinding the substrate. However, this grinding weakens the strength of the substrate. This tends to crack and warp the substrate. Further, because a thinned substrate cannot be transferred automatically, such a substrate needs to be manually transferred. Therefore, handling of such a substrate was cumbersome.

In order to solve this problem, a method for preventing the occurrence of cracking and warping of a substrate has been developed. According to the method, the substrate to be ground is attached to a glass support plate by use of an adhesive so that strength of the substrate is maintained (See Patent Literature 1).

However, in the method described in Patent Literature 1, in a case where any substance such as an organic substance is adhered to the support plate, a small gap is produced between the substrate and the support plate. This damages the substrate. Therefore, as a pretreatment prior to attachment of the substrate, it is necessary to clean the support plate.

Typically, a support plate has a surface area that is equal to or more than a surface area of a substrate. Accordingly, if wirings are formed on the substrate being supported by such a support plate, metal adheres to an exposed peripheral portion of the support plate that is not covered by the substrate. Further, an adhesive remains on the support plate after the substrate is stripped from the support plate. Therefore, for reusing the support plate, a substance such as metal and/or an organic substance that adheres to the support plate needs to be completely removed from the support plate after the substrate is stripped from the support plate.

In general, metal and/or an organic substance each of which is adhered to a support plate can be removed by using a chemical such as acid, alkali, and/or an organic solvent. For example, the metal can be removed by use of aqua regia. Meanwhile, the organic substance can be removed by use of an organic solvent or acid.

As a method of cleaning a glass substrate, Patent Literature 2 discloses a method according to which metal and/or an organic substance that is adhered to the glass substrate is removed by treating the glass substrate by use of a mixture of heated sulfuric acid and hydrogen peroxide solution.

Patent Literature 3 discloses a method according to which a substance adhering a glass substrate is removed by cleaning the glass substrate by use of acid.

Further, Patent Literature 4 discloses a method for removing a metal film. According to this method, when a metal film formed on a circuit substrate is melted and removed by irradiating laser beam onto the metal film, a portion to be a target of the laser beam irradiation is covered by liquid that transmits laser beam so that the circuit substrate is not damaged due to heat of the laser beam.

### CITATION LIST

Patent Literature 1

Japanese Patent Application Publication, Tokukai, No. 2005-191550 A (Publication Date: Jul. 14, 2005)

Patent Literature 2

Japanese Patent Application Publication, Tokukaihei, No. 9-227170 A (Publication Date: Sep. 2, 1997)

Patent Literature 3

Japanese Patent Application Publication, Tokukaishou, No. 62-235236 A (Publication Date: Oct. 15, 1987)

Patent Literature 4

Japanese Patent Application Publication, Tokukaishou, No. 63-180393 A (Publication Date: Jul. 25, 1988)

### SUMMARY OF THE INVENTION

### Technical Problem

However, according to conventional techniques disclosed in Patent Literatures 1 through 4, though an organic substance and a metal film each adhered to a support plate can be removed, waste solution is produced after cleaning of the support plate. Accordingly, in the conventional techniques, treatment of such waste solution is troublesome and costly. In addition, in a case where a chemical such as acid, hydrogen peroxide solution, and/or an organic solvent is used, cleaning costs become high.

The present invention is attained in view of the above problems. An object of the present invention is to attain a method of cleaning a support plate that produces no waste solution after cleaning of the support plate and that allows treatment at low cost.

### Solution to the Problem

In order to solve the problem described above, a method of the present invention of cleaning a support plate being attached to and supporting a substrate, such that the substrate is capable of being thinned, the method includes the step of: performing a carbon dioxide blasting treatment for removing an organic substance and metal each adhered to the support plate, by causing dry ice particles to hit the support plate, the support plate being a support plate from which the substrate has been stripped.

According to the method of the present invention of cleaning a support plate, dry ice particles are generated by turning liquefied carbon dioxide into micro dry ice and caused to hit the support plate. This removes an organic substance and metal each adhered to the support plate. After the dry ice particles hits the support plate, the dry ice particles sublimate. Accordingly, there is no need to treat waste solution or the like after cleaning of the support plate. Therefore, according to the method of the present invention of cleaning a support plate, while no waste solution is produced after cleaning the support plate, the support plate can be cleaned at low cost.

### Advantageous Effects of the Invention

A method of the present invention of cleaning a support plate being attached to and supporting a substrate, such that the substrate is capable of being thinned, the method is configured to include the step of: performing a carbon dioxide blasting treatment for removing an organic substance and metal each adhered to the support plate, by causing dry ice particles to hit the support plate, the support plate being a support plate from which the substrate has been stripped.

Therefore, according to the method of the present invention of cleaning a support plate, while no waste solution is produced after cleaning the support plate, the support plate can be cleaned at low cost.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a diagram briefly illustrating a configuration of a CO₂ blasting apparatus.

FIG. 2 is a diagram schematically showing a perforated support plate, as an exemplary support plate to be a target of a treatment of the present invention.

FIG. 3 is a diagram schematically illustrating an exemplary configuration of a laminated body.

FIG. 4 is a diagram illustrating an exemplary configuration of a support plate cleaning apparatus according to an embodiment of the present invention.

### DETAILED DESCRIPTION OF THE PREFERRED EMBODIMENT

The following describes an embodiment of the present invention in detail. However, note that the present invention is by no means limited to this embodiment but may be implemented in a form in which various modification is added within the scope described herein. Further, entire contents of professional literatures and patent literatures cited in the present specification are incorporated as references in the present specification. Note that “A to B” indicating a range of numerical values means “A or more and B or less” in the present specification unless specifically noted otherwise.

[1. Method of Cleaning Support Plate]

The following describes a method of cleaning a support plate according to the present invention. The method of the present invention of cleaning a support plate being attached to and supporting a substrate, such that the substrate is capable of being thinned, the method includes the step of: performing a carbon dioxide blasting treatment for removing an organic substance and metal each adhered to the support plate, by causing dry ice particles to hit the support plate. In the method of cleaning a support plate of the present invention, the support plate to be treated is a support plate from which the substrate has been stripped.

Note that the cleaning method of the present invention is intended to treat any support plate that is attached to and supports a substrate to be thinned. Accordingly, the support plate may be made of any material as long as the material has sufficient strength for supporting a substrate attached to the support plate. Examples of the material of the support plate are glass, metal, ceramic, or silicon.

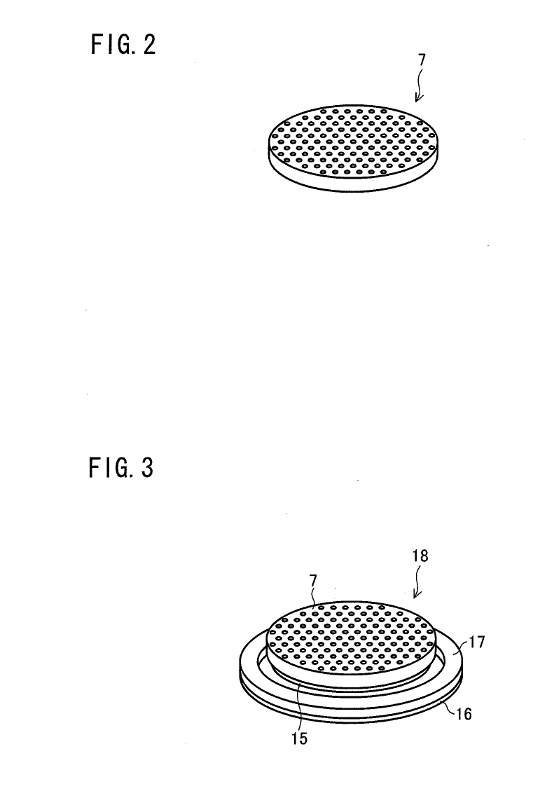

Here, the following describes an exemplary support plate to be a target of a treatment of the present invention, with reference to FIG. 2. FIG. 2 is a diagram schematically showing a perforated support plate.

As shown in FIG. 2, a perforated support plate means a support plate provided with a plurality of through holes penetrating the support plate in a thickness direction of the support plate. More specifically, the perforated support plate has through holes that are formed at a pitch in a range of 0.5 mm to 1.0 mm so as to have a diameter of the through holes in a range of 0.3 mm to 0.5 mm. The through holes are used for supplying a solvent for dissolving an adhesive layer between the support plate and the substrate, when the substrate is stripped from the support plate.

Here, an exemplary configuration of a support plate (hereinafter, referred to as a “laminated body”) to which a substrate is attached is described with reference to FIG. 3. FIG. 3 is a diagram schematically illustrating an exemplary configuration of the laminated body 18. In the laminated body 18, a substrate 15 is attached to a support plate 7 by using an adhesive and moreover, a dicing tape 16 is attached to the substrate 15. The dicing tape 16 is held by a dicing frame 17 for preventing the dicing tape 16 from slacking. The substrate 15 has a surface to be attached to the support plate 7, and a circuit or the like is formed on this surface according to need.

The method of the present invention of cleaning a support plate further includes the step of performing an oxygen plasma treatment for removing an organic substance adhered to the support plate by putting the support plate in contact with oxygen plasma, in addition to the step of performing the carbon dioxide blasting treatment. In the step of performing the oxygen plasma treatment, by putting a support plate in contact with oxygen plasma, an organic substance adhered to the support plate can be removed. Accordingly, in combination of the steps of performing the carbon dioxide blasting treatment and the oxygen plasma treatment, the organic substance adhered to the support plate can be more efficiently removed.

Further, the method of the present invention of cleaning a support plate may further include the step of performing a laser treatment for removing metal adhered to the support plate by irradiating laser beam onto the support plate. By additionally combining the step of performing the laser treatment, metal adhered to the support plate can be more efficiently removed.

In the method of the present invention of cleaning a support plate, in a case where the “step of performing the carbon dioxide blasting treatment” and the “step of performing the oxygen plasma treatment” are combined, either step may be performed first. However it is preferable to first perform the “step of performing the oxygen plasma treatment” and then perform the “step of performing the carbon dioxide blasting treatment”. More specifically, in the step of performing the carbon dioxide blasting treatment, it requires time to remove an organic substance adhered to the through holes (See FIG. 2) of the support plate. On the other hand, in the step of performing the oxygen plasma treatment, it is possible to efficiently remove an organic substance adhered to the through holes of the support plate. Therefore, it is preferable to first carry out the step of performing the oxygen plasma treatment for removing the organic substance adhered to the through holes and a surface of the support plate and then to carry out the step of performing the carbon dioxide blasting treatment for removing an organic substance and metal left on the support plate.

Further, in a case where the “step of performing the carbon dioxide blasting treatment”, the “step of performing the oxygen plasma treatment”, and the “step of performing the laser treatment” are used in combination, the steps may be performed in the order of, for example, the “step of performing the oxygen plasma treatment”, the “step of performing the carbon dioxide blasting treatment”, and “the step of performing the laser treatment”. Alternatively, the steps may be performed in the order of the “step of performing the carbon dioxide blasting treatment”, the “step of performing the oxygen plasma treatment”, and “the step of performing the laser treatment”. As a further alternative, the “step of performing the laser treatment” may be performed first.

The following explains the “step of performing the carbon dioxide blasting treatment”, the “step of performing the oxygen plasma treatment”, and “the step of performing the laser treatment”.

(1-1. Step of Performing Carbon Dioxide Blasting Treatment)

The step of performing the carbon dioxide blasting treatment (hereinafter, also referred to as a “CO₂ blasting treatment step”) is a step of removing an organic substance and metal each adhered to a support plate by causing dry ice particles to hit the support plate from which a substrate has been stripped.

Here, the “dry ice particles” are intended to mean dry ice particles having an average diameter of 0.5 mm or less. The “organic substance” includes, for example, a residual of an adhesive (temporary bonding agent) that has been used for attaching the support plate and the substrate. More specifically, the “organic substance” includes a residual of an acrylic adhesive, a maleimide adhesive, a hydrocarbon adhesive, and/or the like. Examples of the acrylic adhesive are adhesives using acrylic resin as disclosed in Japanese Patent Application Publication, Tokukai, No. 2008-63464, and Japanese Patent Application Publication, Tokukai, No. 2008-133405. An example of the maleimide adhesive is an adhesive using resin having a maleimide skeleton in a main chain as disclosed in Japanese Patent Application Publication, Tokukai, No. 2010-24435. An example of the hydrocarbon adhesive is an adhesive using resin that contains cyclic olefin resin in a main chain as disclosed in Japanese Patent Application Publication, Tokukaihei, No. 9-176398. In addition, the “metal” is intended to mean metal that is typically used for forming a circuit on a substrate. Examples of such metal are Al, Ti, Zr, Cd, Au, Ag, Pt, Pd, Zn, Ni, Cu, and Sn.

In the CO₂ blasting treatment step, means for causing the dry ice particles to hit the support plate may be a conventionally known carbon dioxide blasting apparatus (CO₂ blasting apparatus). The CO₂ blasting apparatus may be a single plate type or alternatively a batch type.

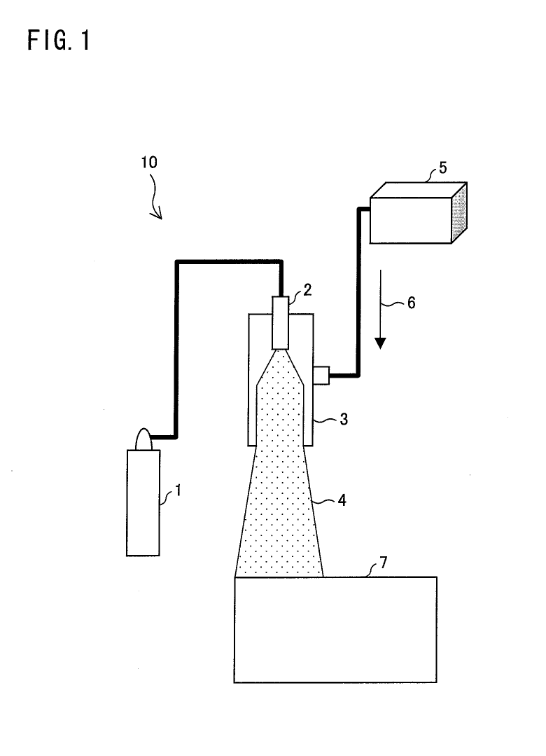

Here, the following explains an exemplary configuration of the CO₂ blasting apparatus, with reference to FIG. 1. FIG. 1 is a diagram briefly illustrating a configuration of a CO₂ blasting apparatus 10. In FIG. 1, the reference sign 4 indicates a collection of individual dry ice particles that are drawn in dots. An arrow indicated by the reference sign 6 indicates a direction of a carrier air jet.

As shown in FIG. 1, in the CO₂ blasting apparatus 10, when a solidification nozzle 2 jets a pressurized liquefied carbon dioxide that is stored in a liquefied carbon dioxide cylinder 1, a volume of the liquefied carbon dioxide expands and a temperature of the liquefied carbon dioxide suddenly lowers. As a result, the liquefied carbon dioxide becomes dry ice particles 4. A jet of the dry ice particles 4 generated as described above is directed onto the support plate 7 from a jet nozzle 3, together with a high-pressure carrier air that is pressurized in a compressor 5.

Here, a pressure of the carrier air jetted together with the jet of the dry ice particles is typically in a range of 0.5 MPa to 30 MPa and preferably in a range of 0.8 MPa to 1.2 MPa. When the pressure of the carrier air is in the above range, it is possible to improve a flow rate of the jet of the dry ice particles shot out from the jet nozzle and also to give the dry ice particles a projecting pressure that is sufficient for cleaning the support plate. Note that the “pressure of the carrier air” is a value obtained by reading an indicator of the compressor that applies pressure to the carrier air. The “carrier air” may be, for example, the air (atmospheric air), or N₂.

A distance between the jet nozzle 3 and the support plate 7 (hereinafter, also referred to as a “nozzle distance”) is typically in a range of 10 mm to 100 mm and preferably in a range of 20 mm to 50 mm. Note that the “nozzle distance” means a distance from a jet orifice of the jet nozzle 3 to an upper surface of the support plate 7.

Further, an outer diameter of the jet nozzle 3 (hereinafter, also referred to as a “jet nozzle outer diameter”) is typically in a range of 1 mm to 20 mm and preferably in a range of 5 mm to 10 mm. Note that the “jet nozzle outer diameter” indicates an outer diameter of the jet orifice of the jet nozzle 3.

Note that, in a case where the dry ice particles are continuously caused to hit the support plate, the support plate is cooled excessively. As a result, dew formation tends to occur on the support plate. The dew drops formed on the support plate are cooled and frozen by the dry ice particles. The frozen dew drops cover an adhesive adhered to the support plate. This deteriorates an efficiency of removal of the adhesive. Therefore, it is preferable to arrange a time (contact time) for which the dry ice particles are continuously caused to hit one area of the support plate to be as short as possible so that the support plate is not cooled excessively.

More specifically, the “contact time” is preferably in a range of 1 second to 60 seconds and more preferably in a range of 1 second to 20 seconds.

In the CO₂ blasting treatment step, the treatment in which the dry ice particles are continuously caused to hit the support plate in the contact time in the above described range (dry ice contact treatment) is repeated a plurality of times for each one area of the support plate. This makes it possible to remove an adhesive adhered to the support plate. In this case, it is preferable to provide, between one dry ice contact treatment and a next dry ice contact treatment, a pausing period of some seconds to some minutes in which the dry ice particles are not caused to hit the each one area. This makes it possible to remove an adhesive adhered to the support plate under a condition where the dew formation is difficult to occurs on the support plate. Note that the number of times at which the dry ice contact treatment is repeated (the number of times of treatment) can be set as appropriate in accordance with a degree of adhesion of the adhesive on the support plate. That is, in a case where the adhesive is lightly adhered to the support plate, the adhesive can be sufficiently removed by a small number of times of treatment. On the other hand, in a case where the adhesive is heavily adhered to the support plate, the number of times of treatment can be increased in accordance with a degree of removal of the adhesive.

Though it depends on the jet nozzle outer diameter, the nozzle distance, and/or the like, an area of the support plate in which area the dry ice particles can hit the support plate is limited in a state where respective positions of the jet nozzle and the support plate are fixed. For solving this problem, for example, the jet nozzle may be moved with respect to the support plate at a speed that provides the contact time as described above or the support plate can be rotated with respect to the jet nozzle so that a position on the support plate on which position the dry ice particles hit the support plate is moved. This makes it possible to remove an adhesive from an entire surface of the support plate.

Further, in the CO₂ blasting treatment step, it is preferable that the dry ice particles are caused to hit the support plate while the support plate is heated to a temperature that is equal to or higher than a room temperature. This configuration is preferable because this makes dew formation difficult to occur on the support plate. In a case where “the temperature of the support plate” is in a range of a room temperature to 100° C., it is possible to efficiently remove an adhesive adhered to the support plate under a condition where dew formation is difficult to occur. Note that the “room temperature” is intended to indicate a temperature in a range of 23° C. to 25° C.

In one embodiment, in a case where a single plate type CO₂ blasting apparatus is used, treatment conditions are as follows, for example: a pressure of carrier air: 1.0 MPa; a treatment time: (2 seconds in contact and 2 seconds in pause)×50 times; a nozzle distance: 30 mm; and a jet nozzle outer diameter: φ7 mm.

In the CO₂ blasting treatment step, a method for causing the dry ice particles to hit the support plate may be any method that makes it possible to remove an organic substance and metal. For example, the system may be a single-plate treatment method or a batch treatment method. Further, in the CO₂ blasting treatment step, the dry ice particles may be caused to hit both sides of the support plate or with only one side of the support plate. In a case where the CO₂ blasting treatment step is carried out by a single-plate treatment method and the dry ice particles are caused to hit both sides of the support plate, preferably, the support plate is pinned up.

(1-2. Step of Performing Oxygen Plasma Treatment)

The step of performing oxygen plasma treatment (hereinafter, also referred to as an oxygen plasma treatment step) is a step of removing an organic substance adhered to the support plate by putting the support plate in contact with oxygen plasma. The “organic substance” includes, for example, a residual of an adhesive (temporary bonding agent) that is used for attaching the support plate with the substrate. More specifically, the “organic substance” includes a residual of an acrylic adhesive, a maleimide adhesive, a hydrocarbon adhesive, and/or the like.

In the oxygen plasma treatment step, a conventionally known oxygen plasma generating apparatus can be used as means for putting the support plate in contact with the oxygen plasma. Typical types of the oxygen plasma generating apparatus include a single plate type and a batch type. However, the present invention is not limited to these types.

The oxygen plasma treatment may employ any condition, as long as an organic substance can be removed under the condition. For example, in the case of the batch type oxygen plasma generating apparatus, an output of the oxygen plasma put in contact with the support plate is typically in a range of 500 W to 2000 W, and preferably in a range of 800 W to 1500 W. Further, in the case of the single plate type oxygen plasma generating apparatus, the output is typically in a range of 1000 W to 3000 W, and preferably in a range of 1500 W to 2500 W.

A pressure of the oxygen plasma put in contact with the support plate is typically in a range of 40 Pa to 266 Pa and preferably in a range of 67 Pa to 200 Pa.

In the case of the batch type oxygen plasma generating apparatus, a oxygen flow rate of the oxygen plasma put in contact with the support plate is typically in a range of 100 sccm to 1000 sccm, and preferably in a range of 200 sccm to 800 sccm. In the case of the single plate type oxygen plasma generating apparatus, the oxygen flow rate is typically in a range of 1000 sccm to 5000 sccm, and preferably in a range of 2000 sccm to 4000 sccm. Note that the unit “sccm” is an abbreviation of “standard cc/min” and indicates an oxygen flow rate standardized at a constant temperature at 1 atm (under atmospheric pressure of 1013 hPa).

In the case of the batch type oxygen plasma generating apparatus, a treatment time by use of the oxygen plasma put in contact with the support plate is typically in a range of 20 minutes to 90 minutes, and preferably in a range of 30 minutes to 60 minutes. In the case of the single plate type oxygen plasma generating apparatus, the treatment time is typically in a range of 5 minutes to 30 minutes, and preferably in a range of 10 minutes to 20 minutes.

In one embodiment, in a case where the batch type oxygen plasma generating apparatus is used, treatment conditions are, for example, Output: 900 W, Pressure: 133 Pa (1 Torr), Oxygen Flow Rate: 350 sccm, and Treatment Time: 60 minutes.

In another embodiment, in a case where the single plate type oxygen plasma generating apparatus is used, treatment conditions are, for example, Output: 2000 W, Pressure: 67 Pa (0.5 Torr), Oxygen Flow Rate: 3000 sccm, Treatment Time: 10 minutes; and Stage Temperature: 240° C.

In the oxygen plasma treatment step, an oxygen plasma treatment method may be in any method as long as an organic substance can be removed by the method. For example, the oxygen plasma treatment method may be a single-plate treatment method or a batch treatment method. Further, in the oxygen plasma treatment step, both sides of the support plate may be put in contact with oxygen plasma. Alternatively, only one side of the support plate may be put in contact with oxygen plasma. In a case where the single-plate treatment method is used and both sides of the support plate are put in contact with oxygen plasma, the support plate is preferably pinned up.

(1-3. Step of Performing Laser Treatment)

The step of performing the laser treatment (hereinafter, also referred to as a laser treatment step) is a step of removing metal adhered to the support plate by irradiating laser beam onto the support plate. The metal to be removed in the laser treatment step is intended to mean metal that is generally used for formation of a circuit on a substrate. Examples of such metal can be Al, Ti, Zr, Cd, Au, Ag, Pt, Pd, Zn, Ni, Cu, and Sn.

Laser beam used in the laser beam irradiation in the laser treatment step may be any laser beam having an oscillation wavelength at a high peak power.

The laser beam irradiation may employ any condition as long as the metal can be removed under the condition. For example, a frequency of the laser beam in the laser beam irradiation onto the support plate is preferably in a range of 10 kHz to 100 kHz, in a case where a laser wavelength is approximately 1000 nm. Further, in a case where the laser wavelength is approximately 500 nm, the frequency of the laser beam is typically in a range of 1 Hz to 60 Hz, and preferably in a range of 20 Hz to 40 Hz.

In a case where the laser wavelength is approximately 1000 nm, an irradiation output of the laser beam for irradiation onto the support plate is preferably in a range of 10 mJ to 200 mJ. Further, in a case where the laser wavelength is approximately 500 nm, the irradiation output is typically in a range of 10 mJ to 100 mJ, and preferably in a range of 20 mJ to 30 mJ.

In one embodiment, in a case where a laser having a laser wavelength of 1000 nm is used as a laser irradiation apparatus, treatment conditions are Laser Output: 160 mJ, and Frequency: 50 kHz.

In another embodiment, in a case where a laser having a laser wavelength of 500 nm is used as the laser irradiation apparatus, treatment conditions are Laser Output: 25 mJ, and Frequency: 30 Hz.

In the laser treatment step, a laser beam irradiation method may employ any condition as long as metal adhered to the support plate can be removed under the condition. Note that, in view of preventing removed metal from adhering to another position on the support plate, the laser beam irradiation is performed onto the support plate more preferably from a backside of the support plate. The backside is opposite to a surface of the support plate to which surface the metal adheres. Further, the laser beam irradiation method may be a single-plate irradiation method or a batch irradiation method.

Removal of an organic substance and metal from the support plate by the method of the present invention of cleaning a support plate can be evaluated by a check of whether or not there is an adhered substance in visual observation of the support plate under a microscope. The removal of the organic substance and metal from the support plate also can be evaluated by, for example, chemical composition analysis of a substance adhered to the support plate, electron diffraction of the support plate, or energy dispersive X-ray spectrometry (EDX) other than the check in visual observation.

[2. Support Plate Cleaning Apparatus]

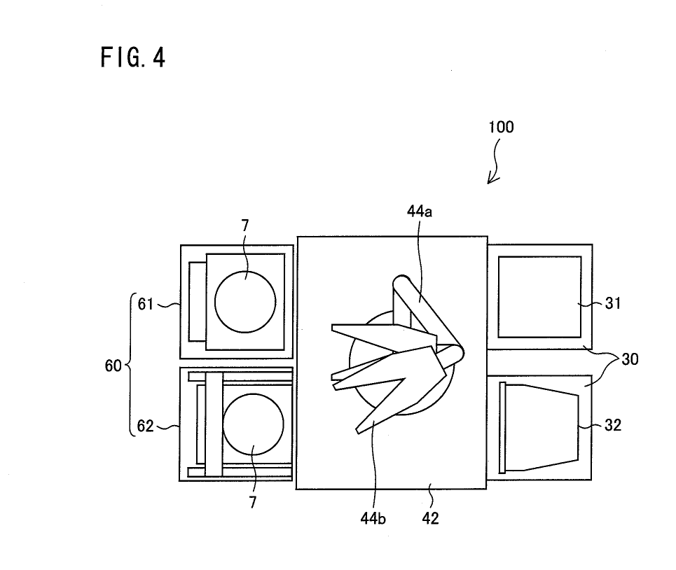

The following describes an exemplary configuration of a support plate cleaning apparatus according to an embodiment of the present invention, with reference to FIG. 4. FIG. 4 is a diagram illustrating an exemplary configuration of a support plate cleaning apparatus 100 of the present embodiment. The support plate cleaning apparatus 100 is used to clean a support plate from which a substrate has been stripped.

The support plate cleaning apparatus 100 includes an oxygen plasma treatment unit 61, a carbon dioxide blasting treatment unit 62, a transfer robot 42, and a cassette station 30. In the cassette station 30, cassettes 31 and 32 are stored. Note that in the present specification, each “cassette” stores therein a support plate 7 to be cleaned or a support plate 7 having been cleaned.

From the support plate 7 from which the substrate has been stripped, an organic substance adhered to the support plate 7 is removed by the oxygen plasma treatment unit 61 and further, an organic substance and metal each adhered to the support plate 7 is removed by the carbon dioxide blasting treatment unit 62.

The carbon dioxide blasting treatment unit 62 is configured to be able to cause the dry ice particles to hit the support plate 7. This makes it possible to remove an organic substance and metal each adhered to the support plate by causing the dry ice particles to hit the support plate 7. Any conventionally known CO₂ blasting apparatus can be used as the carbon dioxide blasting treatment unit 62. The CO₂ blasting apparatus that can be used may be a batch type, a single plate type, or the like type.

Preferably, the carbon dioxide blasting process unit 62 further includes a heating device (not shown) for heating the support plate 7 and a rotation stage (not shown) for rotating the support plate 7. This makes it possible to cause the dry ice particles to hit the support plate 7 while heating the support plate. Consequently, dew formation on the support plate 7 becomes difficult to occur. Further, the dry ice particles can be caused to hit the support plate 7 while the support plate 7 is rotated. As a result, the dry ice particles can hit all over a surface of the support plate 7 while a change in size of the jet nozzle for the dry ice particles is not required.

The oxygen plasma treatment unit 61 is configured to be capable of putting the support plate 7 in contact with oxygen plasma. This makes it possible to remove an organic substance adhered to the support plate 7 by putting the support plate 7 in contact with oxygen plasma. The oxygen plasma treatment unit 61 may be any conventionally known oxygen plasma generating apparatus and may be, for example, the batch type or the single plate type.

Further, in the case of the oxygen plasma treatment unit 61 is a single plate type, preferably, the oxygen plasma treatment unit 61 further includes a pinup apparatus (not shown). This makes it possible to put the support plate 7 in contact with oxygen plasma, keeping the support plate 7 pinned up. Therefore, both sides of the support plate 7 can be put in contact with oxygen plasma and the organic substance can be efficiently removed.

A transfer of the support plate 7 from the oxygen plasma treatment unit 61 to the carbon dioxide blasting treatment unit 62 is carried out by the transfer robot 42. The transfer robot 42 is capable of rotating around an axis of the transfer robot 42 at the center and includes two connected arms 44a and a hand 44b. The connected arms 44a expand/contract by rotation at a joint. The hand 44b is provided to each end of the connected arms 44a and functions to hold the cassette 31 or 32 or the support plate 7. The transfer robot 42 makes it possible to transfer the cassette 31 or 32 or the support plate 7 within a horizontal plane by the expansion/contraction of the connected arms 44a and the rotation around an axis 42a.

In the support plate cleaning apparatus 100, preferably, the oxygen plasma treatment unit 61 and the carbon dioxide blasting treatment unit 62 are disposed so that, after an organic substance adhered to the support plate 7 is removed in the oxygen plasma treatment unit 61, an organic substance and metal each adhered to the support plate 7 is removed in the carbon dioxide blasting treatment unit 62.

The support plate cleaning apparatus 100 of the present embodiment may further include a laser treatment unit (not shown). By including the laser treatment unit, it is possible to further remove metal left on the support plate 7 after treatment in the carbon dioxide blasting treatment unit 62.

The laser treatment unit is configured to be capable of irradiating laser beam onto the support plate. This makes it possible to irradiate laser beam onto the support plate and to remove metal adhered to the support plate. The laser treatment unit may be any conventionally known laser irradiation apparatus.

Note that the support plate cleaning apparatus 100 of the present embodiment can be combined with a stripping apparatus for stripping a substrate from the support plate, and a substrate cleaning apparatus for cleaning the substrate which has been stripped from the substrate in the stripping apparatus.

Preferably, the method of the present invention of cleaning the support plate further includes the step of: performing an oxygen plasma treatment for removing an organic substance adhered to the support plate, by putting the support plate in contact with oxygen plasma.

In the method of the present invention of cleaning the support plate, preferably, the step of performing the carbon dioxide blasting treatment is carried out after the step of performing the oxygen plasma treatment.

In the method of the present invention of cleaning the support plate, preferably, the dry ice particles are caused to hit the support plate while the support plate is being heated.

Preferably, the method of the present invention of cleaning the support plate further includes the step of: performing a laser treatment for removing metal adhered to the support plate, by irradiating laser beam onto the support plate.

The present invention is not limited to the description of the embodiments above, but may be altered by a skilled person within the scope of the claims. An embodiment based on a proper combination of technical means disclosed in different embodiments is encompassed in the technical scope of the present invention.

### EXAMPLES

The following concretely describes the present invention by using Examples. However, the present invention is not limited to these Examples.

### Example 1

### Support Plate for Evaluation

In the present example, as a support plate for evaluation, a dried support plate has been used in a semiconductor production process and a substrate has been stripped from the substrate. To the support plate for evaluation, an acrylic adhesive as an organic substance and aluminum, copper, gold, nickel and the like as metal were adhered. The support plate for evaluation was made of nonalkali glass and had a size of 8 inches.

(Process Flow)

In Example 1, only the carbon dioxide blasting treatment step was performed.

(Evaluation Method)

Removal of the organic substance and the metal were checked by visual observation of the support plate under a microscope.

(Carbon Dioxide Blasting Treatment Step)

The carbon dioxide blasting treatment step was carried out by using a CO₂ blasting apparatus. A treatment method was a single plate treatment method. More specifically, one cycle of the carbon dioxide blasting treatment was arranged to be an operation in which, after dry ice particles were caused to hit, for two seconds, a surface of the support plate to which surface a substance was adhered, a two-second pause in hitting by the dry ice particles was provided. This cycle was repeated 50 times. Other conditions for the carbon dioxide blasting treatment were as follows:

Pressure of Carrier Air: 1.0 MPa

Outer Diameter of Jet Nozzle: φ7 mm

Nozzle Distance: 30 mm.

(Result)

After the carbon dioxide blasting treatment step, removal of an organic substance and metal was checked by visual observation under a microscope. Table 1 shows a result of the visual observation.

TABLE 1

Results of Visual Observation

| | Organic Substance | Metal |
|---|---|---|
| Example 1 | ✓ | ✓ |

The check “√” in Table 1 indicates that no adherence of the organic substance and the metal was observed in the visual observation of the support plate under the microscope.

As shown in Table 1, it was confirmed that the organic substance and the metal each adhered to the support plate could be removed by causing the dry ice particles to hit the support plate.

### INDUSTRIAL APPLICABILITY

According to the method of cleaning a support plate of the present invention, the support plate can be cleaned at low cost while no waste solution is produced after cleaning of the support plate. This method of cleaning the support plate according to the present invention is widely utilized in all electronics industries using a support plate.

### REFERENCE SIGNS LIST

1 liquefied carbon dioxide cylinder
2 solidification nozzle
3 injection nozzle
4 dry ice particles
5 compressor
7 support plate
10 CO₂ blasting apparatus

What is claimed is:

1. A method of cleaning a support plate which is attached to and supports a substrate, wherein the substrate is capable of being thinned, comprising performing a carbon dioxide blasting treatment to remove an organic substance and metal each adhered to the support plate, by causing dry ice particles to hit the support plate, wherein the support plate is a support plate from which the substrate has been stripped.

2. The method of cleaning the support plate according to claim 1, further comprising contacting the support plate with oxygen plasma to remove an organic substance adhered thereto.

3. The method of cleaning the support plate according to claim 2, wherein the carbon dioxide blasting treatment is carried out after performing the oxygen plasma treatment.

4. The method of cleaning the support plate according to claim 1, wherein the dry ice particles hit the support plate while the support plate is being heated.

5. The method of cleaning the support plate according to claim 1, further comprising irradiating a laser beam onto the support plate to remove metal adhered thereto.
